(19) United States
(12) Patent Application Publication
(10) Pub. No.: US 2016/0339627 A1
(43) Pub. Date: Nov. 24, 2016

(54) PRE-STRESSED AND CONSTRAINED TRANSFORMABLE MATERIALS

(71) Applicant: Massachusetts Institute of Technology, Cambridge, MA (US)

(72) Inventors: Skylar JE Tibbits, Boston, MA (US); Athina Papadopoulou, Cambridge, MA (US); David N. Constanza, Somerville, MA (US); Christophe Guberan, La Praz (CH)

(21) Appl. No.: 15/160,393

(22) Filed: May 20, 2016

Related U.S. Application Data
(60) Provisional application No. 62/165,459, filed on May 22, 2015.

(51) Int. Cl. B29C 61/00; B29C 55/16; B29C 67/00

(52) U.S. Cl. CPC B29C 61/006; B29C 67/0059; B29C 55/16; B33Y 10/00

(57) ABSTRACT

A transformable material and comprising a base material having a natural shape, with a second material disposed on the base material in a particular pattern so as to impose a transformed shape on the base material, the transformed shape being different than the natural shape. More particularly, the base material is a stretchable 2-dimensional material, and is subjected to pre-stressing before and during disposition of the second material, whereupon after release of the stress, the stretchable base material with the disposed second material thereon automatically transform into a predetermined 3-dimensional manufactured shape.

### RELATED APPLICATION(S)

This application claims the benefit of U.S. Provisional Application No. 62/165,459, filed on May 22, 2015. The entire teaching of the above application is incorporated herein by reference.

### FIELD OF THE INVENTION

The present invention relates to pre-stressed and constrained transformable materials, methods of making the pre-stressed and constrained transformable materials, and complex transformed shapes formed using the pre-stressed and constrained transformable materials. More particularly, the present invention relates to a method for creating transformable materials by pre-stretching a stretchable base material, followed by printing, laminating or otherwise disposing material constraints thereon to enable the stretchable base material to automatically transform into a precise and predetermined shape.

### BACKGROUND OF THE INVENTION

Many industries require precisely shaped materials to meet aesthetic and/or functional needs. While current manual and automated methods and technologies may possibly meet these needs to some extent, these methods and technologies are often complex, labor intensive with respect to time and skill, and require expensive tools and machinery to produce the desired intricate shapes.

For example, in sports and physical fitness, complex 3D structures for sportswear and equipment are required from a performance and aesthetic perspective. In addition, sportswear and equipment that has a more customized fit and which can provide compression, constraint, and/or protection where needed are in demand. In the related world of fashion design, intricate patterns using pleating and complex stitching details are often utilized. In particular, when designing clothing and footwear, the materials must be formed into shapes having a complex curvature to provide a variety of wearers with a proper fit. Footwear and leather goods are examples of products that rely on industrial forming techniques to stretch and force materials around a physical mold. The physical mold imposes further constraints on the possible number and complexity of the end product given that a new mold is needed for each unique product. These molds tend to be expensive, static and simple due to their manufacture using CNC-machining processes.

In architecture, tensile structures with new details, surface features for performance and/or aesthetics, venting or other properties, and added geometric and physical tension/compression constraints are often used when designing various buildings and other structures.

Interior design utilizes furniture and other products that typically require manual assembly, molding, pleating, tufting, knotting, complex stitching, and other intricate detailing processes. Further, textile-based complex and 3-dimensional interior partitions and other wall treatments are commonly used. These processes often require manual or automated skilled and precise control for production, which increases the time and energy needed to produce each item. This further drives up the price of a textile product, relegating highly detailed products to high-end markets or hand-craft couture spaces.

In the medical and health fields, compression garments with various degrees of compression and tension across the body are needed to help circulate blood flow in custom pathways and to provide support.

In addition, nearly every industry has long desired smarter materials and robotic-like transformation—from apparel, architecture, product design and manufacturing, to aerospace and automotive industries. However, these capabilities have often required expensive, error-prone and complex electromechanical devices (e.g., motors, sensors, electronics), bulky components, power consumption (e.g., batteries or electricity) and difficult assembly processes. These constraints have made it challenging to efficiently produce dynamic systems, higher-performing machines and more adaptive products.

Thus, it would be desirable to provide new materials and methods which make it possible to more easily provide currently manufactured complex 3D shaped materials, and to provide 3D shaped materials that have not been previously attainable. Further, it would be desirable to provide such materials which are further capable of dynamically changing their shape on demand.

### SUMMARY OF THE INVENTION

Embodiments of the present invention provide a novel material, methods of manufacture, and 3-dimensional structures formed therefrom.

According to one aspect, the present invention provides a transformable material comprising a stretchable base material having a natural shape and held under a state of stress in one or more directions, and one or more physical constraints disposed on and/or within the stretchable base material in a predetermined pattern while the stretchable base material is held under the state of stress, wherein the one or more physical constraints comprise one or more materials different than the stretchable base material, and wherein the one or more physical constraints provide the stretchable base material with a predetermined transformed shape different than the natural shape upon release of the state of stress.

According to some embodiments of this transformable material, one or more of the following can be selected. The stretchable base material can be selected from elastomeric materials, textiles, plastics, rubber, and sheet foam. The stretchable base material can be a textile selected from neoprene, jersey, vinyl, stretch velvet, polyesters, compression textiles, knitted or woven textiles, and polyester-polyurethane copolymers, including elastane and spandex. The one or more physical constraints can comprise 3D printed physical constraints. The one or more physical constraints can comprise laminated or adhered physical constraints. The one or more physical constraints can comprise knitted, woven, stitched, or injected physical constraints. The one or more physical constraints can be formed of materials selected from non-stretch textiles, plastics, leather, metal, glues, adhesives, calk, composite materials containing resin, veneer wood, and combinations thereof. The one or more physical constraints can be formed of plastics selected from the group consisting of nylon, polylactic acid (PLA), acrylonitrile butadiene styrene (ABS), and combinations thereof.

According to another aspect, the present invention provides a method of forming a transformable material comprising applying stress to a stretchable base material in one or more directions to form a pre-stressed stretchable base material, and depositing one or more physical constraints onto or within the pre-stressed stretchable base material in a predetermined pattern to provide a pre-stressed physically constrained stretchable base material, wherein the stretchable base material has a natural shape before applying stress and before depositing the one or more physical constraints, wherein the one or more physical constraints comprise one or more materials different than the stretchable base material, and wherein the one or more physical constraints provide the stretchable base material with a predetermined transformed shape different than the natural shape upon release of the applied stress.

According to some embodiments of this method, one or more of the following can be selected. The stretchable base material can be selected from elastomeric materials, textiles, plastics, rubber, and sheet foam. The stretchable base material can be a textile selected from neoprene, jersey, vinyl, stretch velvet, polyesters, compression textiles, knitted or woven textiles, and polyester-polyurethane copolymers, including elastane and spandex. Depositing the one or more physical constraints can comprise 3D printing the one or more physical constraints in the predetermined pattern onto or within the pre-stressed stretchable base material. Depositing the one or more physical constraints can comprise laminating or adhering the one or more physical constraints in the predetermined pattern onto or within the pre-stressed stretchable base material. Depositing the one or more physical constraints can comprise knitting, weaving, stitching, or injecting the one or more physical constraints in the predetermined pattern onto or within the pre-stressed stretchable base material. The one or more physical constraints can be formed of materials selected from non-stretch textiles, plastics, leather, metal, glues, adhesives, calk, composite materials containing resin, veneer wood, and combinations thereof. The one or more physical constraints can be formed of plastics selected from the group consisting of nylon, polylactic acid (PLA), acrylonitrile butadiene styrene (ABS), and combinations thereof. Depositing the predetermined pattern can include depositing predetermined heights and/or widths of the deposited one or more materials along the pattern. The method can further comprise selecting the stretchable base material based on flexibility, stretchability, and resistance of the stretchable base material to applied stress. The transformed shape can be predetermined by selecting one or more of: a particular shape of the stretchable base material, a stretchability of the stretchable base material, a flexibility of the stretchable base material, a thickness of the stretchable base material, a direction and amount of applied stress, a type of material forming the one or more physical constraints, a thickness pattern of the one or more physical constraints, a width pattern of the one or more physical constraints, an overall design pattern of the one or more physical constraints, and a relative location of the one or more physical constraints to applied stress on the stretchable base material. Stress can be applied to the stretchable base material uniformly in all four directions. Stress can be applied to the stretchable base material non-uniformly so as to impart a preferred direction of force.

According to another aspect, the present invention provides a method of forming a 3-dimensional transformed shape comprising applying stress to a stretchable base material in one or more directions to form a pre-stressed stretchable base material, depositing one or more physical constraints onto or within the pre-stressed stretchable base material in a predetermined pattern to provide a pre-stressed physically constrained stretchable base material, and releasing the stress applied to the stretchable base material, wherein the stretchable base material has a natural shape before applying stress and before depositing the one or more physical constraints, wherein the one or more physical constraints comprise one or more materials different than the stretchable base material, and wherein upon releasing the stress applied to the stretchable base material, the one or more physical constraints provide the stretchable base material with a predetermined transformed 3-dimensional shape different than the natural shape of the stretchable base material.

According to some embodiments of this method, one or more of the following can be selected. The stretchable base material can be selected from elastomeric materials, textiles, plastics, rubber, and sheet foam. The stretchable base material can be a textile selected from neoprene, jersey, vinyl, stretch velvet, polyesters, compression textiles, knitted or woven textiles, and polyester-polyurethane copolymers, including elastane and spandex. Depositing the one or more physical constraints can comprise 3D printing the one or more physical constraints in the predetermined pattern onto or within the pre-stressed stretchable base material. Depositing the one or more physical constraints can comprise laminating or adhering the one or more physical constraints in the predetermined pattern onto or within the pre-stressed stretchable base material. Depositing the one or more physical constraints can comprise knitting, weaving, stitching, or injecting the one or more physical constraints in the predetermined pattern onto or within the pre-stressed stretchable base material. The one or more physical constraints can be formed of materials selected from non-stretch textiles, plastics, leather, metal, glues, adhesives, calk, composite materials containing resin, and veneer wood, and combinations thereof. The one or more physical constraints can be formed of plastics selected from the group consisting of nylon, polylactic acid (PLA), acrylonitrile butadiene styrene (ABS), and combinations thereof. Depositing the predetermined pattern can include depositing predetermined heights and/or widths of the deposited one or more materials along the pattern. The method can further comprise selecting the stretchable base material based on flexibility, stretchability, and resistance of the stretchable base material to applied stress. The transformed shape can be predetermined by selecting one or more of: a particular shape of the stretchable base material, a stretchability of the stretchable base material, a flexibility of the stretchable base material, a thickness of the stretchable base material, a direction and amount of applied stress, a type of material forming the one or more physical constraints, a thickness pattern of the one or more physical constraints, a width pattern of the one or more physical constraints, an overall design pattern of the one or more physical constraints, and a relative location of the one or more physical constraints to applied stress on the stretchable base material. Stress can be applied to the stretchable base material uniformly in all four directions. Stress can be applied to the stretchable base material non-uniformly so as to impart a preferred direction of force.

According to another aspect, the present invention provides a method of material transformation comprising applying stress to a stretchable base material in one or more directions to form a pre-stressed stretchable base material, depositing one or more physical constraints onto or within the pre-stressed stretchable base material to provide a pre-stressed physically constrained stretchable base material, and releasing the applied stress from the pre-stressed physically constrained stretchable base material, wherein release of the applied stress from the pre-stressed physically constrained stretchable base material causes the physically constrained stretchable base material to take on a transformed shape.

According to some embodiments of this method, one or more of the following can be selected. The one or more physical constraints can be in the form of one or more materials deposited onto or within the pre-stressed stretchable base material in a predetermined pattern. Depositing the one or more physical constraints can comprise 3D printing the one or more physical constraints in a predetermined pattern onto or within the pre-stressed stretchable base material. Depositing the one or more physical constraints can comprise laminating or adhering the one or more physical constraints in a predetermined pattern onto or within the pre-stressed stretchable base material. Depositing the one or more physical constraints can comprise knitting, weaving, stitching, or injecting the one or more physical constraints in the predetermined pattern onto or within the pre-stressed stretchable base material. Releasing the applied stress from the pre-stressed physically constrained stretchable base material can comprise cutting the stretchable base material along an outline of the deposited one or more physical constraints. Applying stress to the stretchable base material can comprise holding the stretchable base material in a stressing apparatus, and wherein releasing the applied stress comprises releasing the stretchable base material from the stressing apparatus. The method can further comprise selecting the stretchable base material based on flexibility, stretchability, and resistance of the stretchable base material to applied stress. The transformed shape can be predetermined by selecting one or more of: a particular shape of the stretchable base material, a stretchability of the stretchable base material, a flexibility of the stretchable base material, a thickness of the stretchable base material, a direction and amount of applied stress, a type of material forming the one or more physical constraints, a thickness pattern of the one or more physical constraints, a width pattern of the one or more physical constraints, an overall design pattern of the one or more physical constraints, and a relative location of the one or more physical constraints to applied stress on the stretchable base material. Stress can be applied to the stretchable base material uniformly in all four directions. Stress can be applied to the stretchable base material non-uniformly so as to impart a preferred direction of force. The transformed shape can be in the shape of footwear, clothing, an architectural structure, furniture, a wall partition, a window treatment, a compression garment, an automotive interior structure, or an aerospace interior structure.

According to another aspect, the present invention provides a 3-dimensional transformed shape comprising the aspect and embodiments of the transformable material set forth above after releasing the state of stress. According to this aspect, embodiments of the present invention can include predetermined transformed shapes in any form, particularly in the shape of footwear, clothing, an architectural structure, furniture, a wall partition, a window treatment, a compression garment, an automotive interior structure, or an aerospace interior structure.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principals of the invention.

FIG. 1A illustrates a method of pre-stretching with uniform 4-way force distribution and 4-way stretch a stretchable base material according to an embodiment of the present invention, and FIG. 1B illustrates a method of pre-stretching with non-uniform 2-way force distribution and 4-way stretch a stretchable base material according to an embodiment of the present invention.

FIGS. 2A-B illustrate a method of 3D printing physical constraints onto a pre-stretched stretchable base material according to embodiments of the present invention.

FIGS. 3A-C illustrate a method of laminating physical constraints onto a pre-stretched stretchable base material according to embodiments of the present invention.

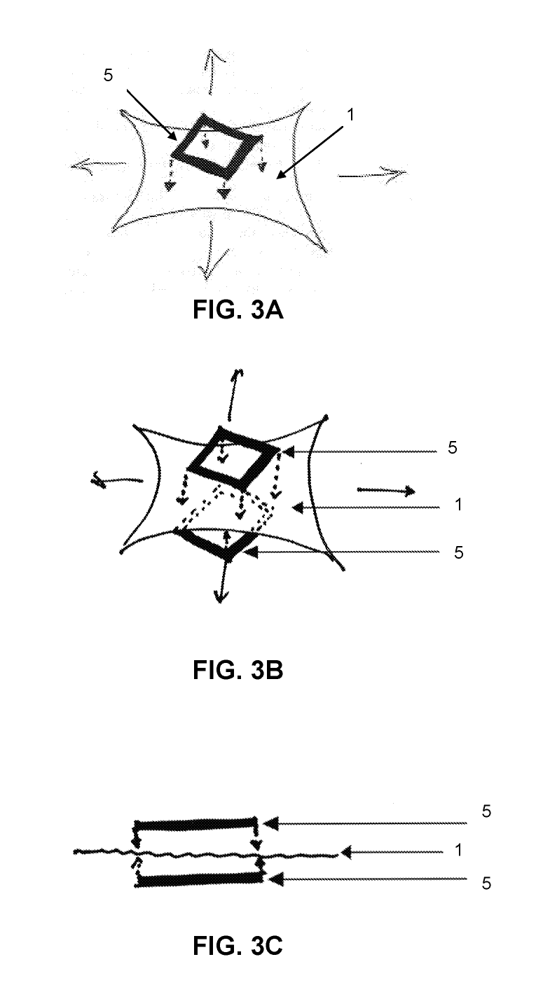

FIGS. 4A-C illustrate a process of releasing a constrained object from a 4-way force distribution on a pre-stretched stretchable base material and the resultant 3-dimensional shape transformation according to an embodiment of the present invention.

FIGS. 5A-C illustrate a process of releasing a constrained object from a 2-way force distribution on a pre-stretched stretchable base material and a resultant 3-dimensional shape transformation according to an embodiment of the present invention.

### DETAILED DESCRIPTION

The following definitions are useful for interpreting terms applied to features of the embodiments disclosed herein, and are meant only to define elements within the disclosure.

As used herein, the term “manufactured shape” or “transformed shape” refers to a predetermined geometrical shape. For example, a manufactured or transformed shape is different from a shape that would occur in a pre-stressed stretchable base material absent application of the physical constraints or application of one or more physical constraints in an uncontrolled manner. In other words, a shape that is not a predetermined shape is not a manufactured or transformed shape. It should be understood that the term “predetermined” does not mean that every parameter, such as volume, angle, stiffness, etc., is known in advance, but rather that a shape is considered to be a manufactured shape if it is generally predicted at the time of producing the object. Depending upon the type of transformation, the actual shape may differ from the predetermined shape by about ±5%, ±10%, ±30%, or ±50%.

As used within this disclosure, a “transformable material” refers to a material that is provided in a first form in its natural state, and which is processed through (a) pre-stressing and (b) adding one or more physical constraints to the pre-stressed material by printing, laminating, adhering or otherwise disposing the physical constraints onto the pre-stressed material. The transformable material is formed in such a way that upon release of the stress from the transformable material, the material with the physical constraints disposed thereon automatically changes into a geometric form that is different than its natural state.

As used within this disclosure, a “stretchable base material” refers to any material that is capable of being stressed in at least one direction so as to embed the stretchable base material with potential energy. Such stretchable base materials are considered elastically stretchable in that they reversibly stretch upon application and release of stress, such that they return entirely or at least partially to their pre-stressed form upon release of the stress. Partial return to a pre-stressed form means that the material returns at least 50%, 60%, 70%, 75%, 80%, 85%, 90% or 95% to their pre-stressed form upon release of the stress. This is in contrast with materials that stretch when stress is applied, and remain mostly or fully in the stretched state upon release of the stress (i.e., the material returns less than 50%, less that 40%, less than 30%, less than 20%, less than 10%, or less than 5% to their pre-stressed form). Such stretchable base materials do not include composite materials. “Composite materials”, as used herein, refer to materials impregnated with a resin, such as, for example, carbon fiber, glass fiber, Kevlar, fiberglass, and basalt fiber, crystal polymers.

As used within this disclosure, a “textile” refers to a type of stretchable base material, and includes woven, knitted, braided, crocheted, felted, and knotted materials formed from natural and/or artificial fibers.

As used within this disclosure, a “physical constraint” is a material that is generally not stretchable (or is minimally stretchable relative to the stretchable base material), but has some flexibility. The physical constraint is a material that is disposed on or within the stretchable base material when the stretchable base material is held under a state of stress, particularly while the stretchable base material is stretched. The physical constraint has different properties than those of the stretchable base material and, thus, causes the stretchable base material to change shape when the stress is released.

The present invention generally provides transformable materials comprising a stretchable base material with one or more physical constraints disposed thereon. The present invention further generally provides a method of forming such transformable materials by applying stress to a stretchable base material, disposing one or more physical constraints on the pre-stressed stretchable base material, and removing the stress from the stretchable base material. Upon removal of the stress from the stretchable base material, the one or more physical constraints disposed thereon cause a precise and predetermined geometric transformation of the stretchable base material. The present invention further generally provides complex structures formed using the transformable materials.

Reference will now be made in detail to embodiments of the present invention, examples of which are illustrated in the accompanying drawings. Wherever possible, the same reference numbers are used in the drawings and the description to refer to the same or like parts.

According to one aspect, the present invention provides a transformable material comprising a stretchable base material 1 with one or more physical constraints 2 disposed thereon. The stretchable base material 1 has a natural state that is typically a flat 2-dimensional shape when resting on a surface, such as that of a piece of Lycra® or other textile. Some of these stretchable base materials 1 may have more stiffness and structure to them than others, wherein some will take on whatever shape they are placed upon (e.g., Lycra® will be flat when placed on a table, and when placed on a dome shape will curve along the dome's curvatures) and others may maintain their internal shape somewhat while partially taking on a shape they are placed upon (e.g., a thick, stiff wool which will be flat when placed on a table, and when placed on a dome may curve somewhat along the shape of the dome, but may also maintain some if it's internal flat, stiff structure).

Some examples of the stretchable base material 1 include, but are not limited to elastomeric materials, textiles, plastics, rubber, and sheet foam, particularly such materials that are elastically/reversibly stretchable. Such materials are typically conventional materials that are used in the clothing, footwear and interior design/furniture industries. These materials are generally in the form of a 2-dimensional sheet of the material (e.g., a piece of fabric), although it is also possible to use what may be considered a 3-dimensional sheet of material which is a material having an added dimension of thickness (particularly in the mm to cm scale thickness). Some examples of suitable stretchable textiles include, but are not limited to, polyester-polyurethane copolymers (e.g., Lycra®, elastane, and spandex), neoprene, jersey, vinyl, stretch velvet, polyesters, and other compression textiles with 4-way stretch. 2-way stretch textiles can also be used as long as such textiles can be pre-stressed, can retain the deposited physical constraints thereon, and can change form into the precise and predetermined geometric transformed shape upon release of the pre-applied stress. In addition a variety of materials that themselves may not conventionally be considered stretchable or elastically stretchable could be considered so if they are formed in a manner that imparts stretch, particularly elastic/reversible stretch. In particular, many conventional fabrics used in making clothing would not necessarily be considered stretchable or elastically stretchable. However, if the fibers making up such fabrics are knitted or woven in such a manner that stretch is imparted, then they would be considered stretchable. For example, while cotton and wool may generally be considered non-stretch materials (cotton and wool fibers generally are not themselves stretchable), loosely knitted or woven cotton or wool would have reversible stretch imparted in them (e.g., the knit or weave may be configured such that it will loosen or pull open/apart to an extent upon application of stress, and would return to an un-stretched state upon release of the stress). The stretchable base material 1 is beneficially a material that does not require disposing the or more physical constraints 2 thereon or therein in any particular orientation relative to a grain pattern, weave pattern, or knit pattern of the fibers of the stretchable base material 1 in order to provide the transformed shape.

The physical constraints 2 are in the form of one or more materials deposited on the stretchable base material 1 in a predetermined and specific shape. The shape is specifically designed and deposited on the stretchable base material so as to provide the stretchable base material with a transformed shape when the following three factors are combined (1) pre-stressing of the stretchable base material 1 in one or more directions so as to embed potential energy therein, (2) depositing the physical constraints 2 on the pre-stressed stretchable base material 1 and allowing the physical constraints 2 to cure/dry (e.g., polymerize) as needed, and (3) releasing the stress from the stretchable base material 1. The physical constraints 2 can be deposited on the stretchable base material 1 using any method that allows for precise deposition of the physical constraint in a desired pattern onto the stretchable base material 1.

Some examples of the materials usable in forming the physical constraints 2 include, but are not limited to non-stretch textiles, plastics, leather, metal, glues, adhesives, calk, composites containing resin, and veneer wood. All of the materials usable as the physical constraints 2 are generally non-stretch materials that have flexibility, and have a stiffness and flexibility that will effectively change the shape of the stretchable base material 1 upon release of stress from the pre-stressed stretchable base material, rather than the physical constraint 2 merely taking on the shape of the stretchable base material 1. As such, the physical constraint 2 must impose properties that influence the shape and structure of the combined material rather than simply taking on the properties/shape of the stretchable base material 1.

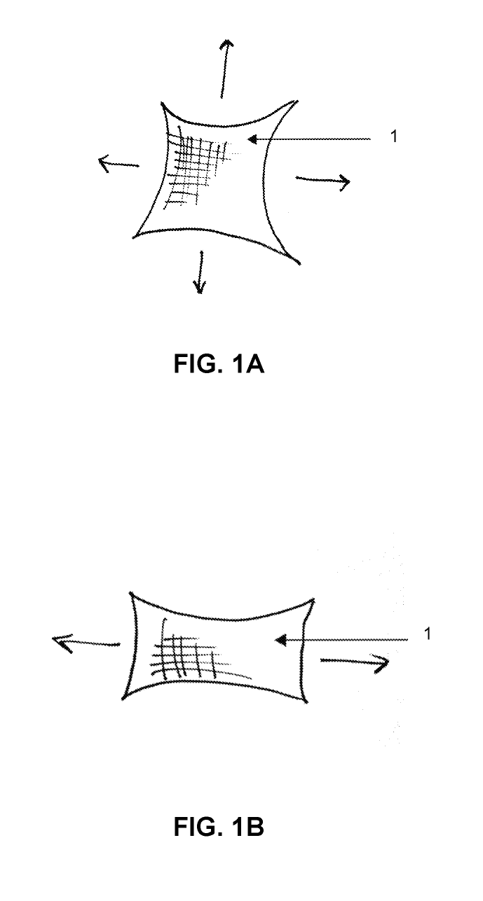

According to various embodiments, a stretchable base material 1 is pre-stressed by stretching the stretchable base material in one or more directions, so that the stretchable base material 1 is subject to tension in one or more directions, thereby embedding the stretchable base material with potential energy. For example, the stretchable base material 1 can be subjected to 4-directional stressing as shown in FIG. 1A, or 2-directional stressing as shown in FIG. 1B. The pre-stressed stretchable base material 1 is held in the stressed configuration while the one or more physical constraints 2 are disposed thereon. The physical constraints 2 generally include one or more materials that are printed, laminated, adhered or otherwise applied or disposed in a particular pattern. The particular pattern is designed so as to cause the stretchable base material 1 to geometrically transform (e.g., by curling, folding, stretching, shrinking, creasing, and the like) into a desired precise and predetermined shape upon release of the stress on the stretchable base material 1. Further, the physical constraints 2 are generally disposed on the stretchable base material so as to remain thereon and provide the transformation of the stretchable base material into the desired precise and predetermined shape after release of the pre-applied stress. In particular, the physical constraints 2 are disposed on or in the stretchable base material 1 to form a structure that acts as a unit—in other words, bending and curving of the physical constraint 2 pattern causes the stretchable base material 1 to also bend and curve along the pattern, such that the physical constraint 2 and the stretchable base material do not come apart, but remain held/bonded together.

The composition and characteristics of the selected stretchable base material 1 plays an important role in the behavior of the pre-stressing, post-transformation, adhesion of the physical constraint materials, and ultimately, the flexibility and ability to physically transform into a desired geometric transformed shape.

Each type of material usable as the stretchable base material 1 has unique characteristics of force and resistance in relation to directionality. A simple implementation consists of a material with 4-way stretch, with uniform stretch and force in each direction. The shape and stretchability of the stretchable base material 1, the direction and amount of pulling force, and the resultant 3-dimensional transformed shape are in relation to the amount and pattern of the physical constraints 2 deposited onto the stretchable base material 1. The flexibility of the stretchable base material also influences the final transformed shape, as it requires the deposited physical constraints 2 to be designed with the correct thickness and/or width in relation to the required force for resisting or accepting the stretchable base material's compression force. This relationship depends on the desired 3-dimensional structure or transformed shape.

FIG. 1A depicts one preferred implementation, which involves pre-stretching the selected stretchable base material 1 in a uniform manner in all four directions as indicated by the outwardly pointing arrows. The stretchable base material 1 can be stretched to its physical limits (or, if desired, can be stretched to an extent less than its physical limits) then clipped or otherwise held, for example, to a rigid substrate (not shown) to maintain the stretching force. Pre-stressing provides activation energy embedded within the stretchable base material 1 to be later released, after deposition of the physical constraints 2, causing the material to “jump” or transform. Once the stretchable base material 1 has been suitably pre-stressed and held/clipped in the desired pre-stressed state, the pre-stretched stretchable base material (together with any holding and stressing apparatus) is then placed within a 3D printer or other lamination or deposition process apparatus to add the desired physical constraints 2 thereto.

According to some embodiments, the stretchable base material 1 is non-uniformly pre-stressed, particularly non-uniformly pre-stretched so as to impart a preferred direction of force. This may cause a single axis of the stretchable base material to bend or curl more after printing and releasing, while the other axis may have less force and curvature. The pattern of non-uniform pre-stretching can be designed in relationship to the printed, laminated, or otherwise deposited physical constraint material so as to produce a desired 3-dimensional transformed shape.

After the stretchable base material 1 has been pre-stressed and fixed in the pre-stressed condition, physical constraints 2 are added onto the pre-stretched stretchable base material 1 in a precise predetermined pattern. The precise predetermined pattern is deposited in a way that promotes the 3-dimensional self-transformation after release of the pre-applied stress on the stretchable base material 1.

In addition to the particular properties of the stretchable base material 1 that is being used in a particular application, and the pre-stressed directions and force placed on the stretchable base material 1, various features of the physical constraints 2 that are disposed on the stretchable base material 1 can be selected and tailored specifically to provide further precision of the desired 3-dimensional transformed shape that is achieved. For example, the type of material forming the physical constraints , the thickness, width and pattern of the physical constraints, as well as the way in which the physical constraints are applied to the pre-stressed stretchable base material in relation to the direction(s) and amount of stress applied can all contribute to the 3-dimensional transformed shape achieved. For example, the height of the deposited physical constraint material will result in more or less flexibility/stiffness, and ultimately will impact the curvature in the final shape. In particular, a thicker (greater height “h”) deposited physical constraint material will be stiffer than a thinner (lesser height “h”) deposition of the same material. A greater stiffness will result in a greater force imposed by the material, but less of a resulting transformation (e.g., less of a bend) because the thicker material is stiffer. On the other hand, the thinner physical constraint 2 imposes less stiffness, less imposed force, but will allow for a greater transformation (e.g., a greater bend) because the thinner physical constraint 2 is more flexible/less stiff. The width of the deposited physical constraint material may also control the amount of flexibility and curvature it provides in different X/Y directions, for example, due to the larger or smaller area the physical constraint material covers. Further, the overall pattern of the deposited physical constraint promotes either a global or a localized curvature and 3-dimensional shape after transformation. In particular, a pattern of a physical constraint 2 that is spread across a majority or larger area of the stretchable base material 1 will provide a global shape transformation over the entire/large area of the stretchable base material 1. On the other hand, a local deposition of physical constraint 2 on only one small portion of the stretchable base material 1 will provide a localized shape transformation over only that small portion of the stretchable base material 1.

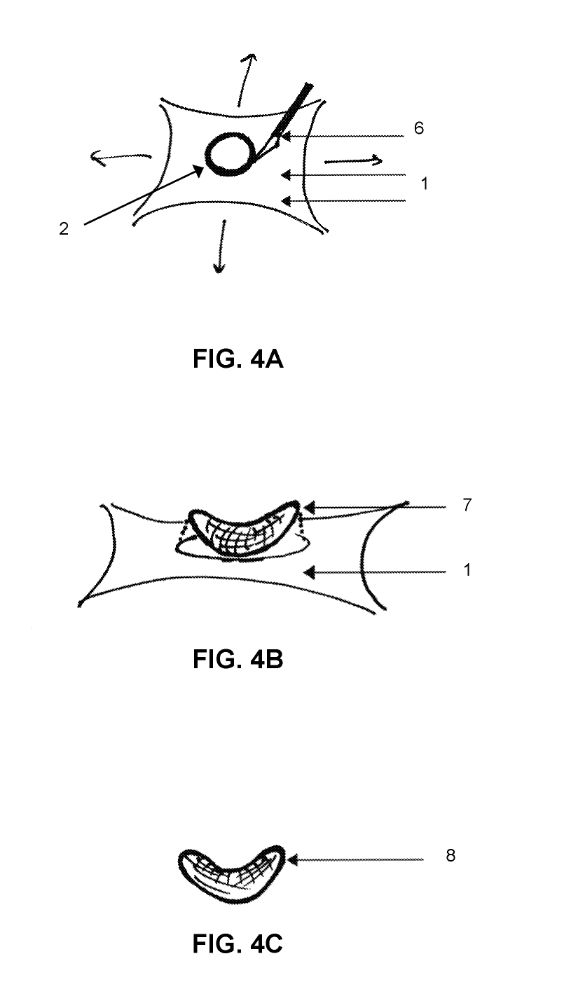

For example, as depicted in FIGS. 4A-4C if a physical constraint 2 in the form of a simple circle is printed or otherwise deposited onto a pre-stretched stretchable base material 1 (FIG. 4A) that is subjected to 4-directional pre-stretching, after the pre-stretched stretchable base material 1 is released from tension—here, by cutting out the circular deposited shape with a cutting tool 6 or the like (FIG. 4B)—the resulting transformed shape 8 will be a precise hyperbolic saddle structure as shown in FIG. 4C.

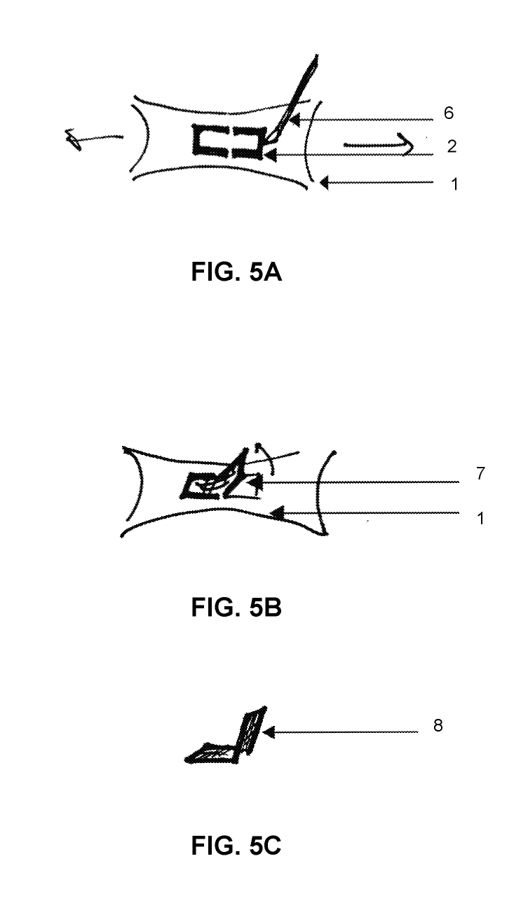

In another example, as depicted in FIGS. 5A-5C, if a stretchable base material 1 is pre-stretched in predominately 2-directions, and a physical constraint 2 in the form of a square is printed onto the pre-stretched stretchable base material 1 parallel with the dominate stretched axis (as depicted by the outwardly extending arrows), with a thinner deposited physical constraint region being printed or otherwise deposited at the midpoints of two opposite edges, while thicker deposited physical constraints regions are printed or otherwise deposited around the rest of the square (FIG. 5A), after the stretchable base material is released from tension—here, by cutting out the square deposited shape with a cutting tool 6 or the like (FIG. 5B)—the resultant transformed shape 8 will be a folded edge with two perpendicular planes of the square as shown in FIG. 5C.

In order to further dictate the final transformed structure, different materials can be utilized to form the deposited physical constraints 2. The flexibility of the deposited material will either promote more curvature or less curvature in proportion to the amount of force introduced on the stretchable base material 1 during pre-stressing.

In one embodiment, any polymeric material, such as plastic-based printed materials like Nylon, polylactic acid (PLA), acrylonitrile butadiene styrene (ABS), is deposited onto a pre-stretched 4-way stretchable stretchable base material. Different materials can offer different types of curvature in predetermined places or patterns, thereby promoting the emergence of complex structures. Further, a single material or multiple materials can be deposited simultaneously on the stretchable base material 1 to create unique flex and stiffness physical constraint patterns across the stretchable base material 1, either in 2-dimensions or in 3-dimensional deposited layers.

According to various embodiments, the 3-dimensional transformed shape is a result of the careful design of one or more of (1) the stretchable base material's properties and 2 or 4-way stretch characteristics, (2) the direction and amount of pre-stressing, and (3) the material property, width, thickness and 2 or 3-dimensional pattern of the added physical constraints. In order to design particular transformed shapes, one can chose to vary each of these contributing factors so that, together, the factors provide the desired transformed shape. Alternatively, one can chose to simplify the relationship of the various materials, properties, and contributing factors by selecting a single property to change while keeping all others constant. For example, the design of a desired transformed shape can be simplified and more easily controlled if a single stretchable base material (e.g., with 4-way stretch) and a 4-way pre-stretch pattern is applied.

This leaves only the pattern and material properties of the physical constraint material. As such, the physical constraint 2 becomes the design or “program” to dictate the final transformed shape. Similarly, other properties can be maintained constant while one or more are varied as needed to achieve a desired transformed shape.

One preferred implementation of adding physical constraints 2 to the stretchable base material 1 is by means of 3D Printing. 3D printing has conventionally been used to create static objects and other stable structures, such as prototypes, products, and molds. Three dimensional printers can convert a 3D image, which is typically created with computer-aided design (CAD) software, into a 3D object through the layer-wise addition of material. In the present invention, 3D printing can be used to create, design, and print a custom height, width and pattern of physical constraints 2 on top of the pre-stretched stretchable base material 1. According to preferred embodiments, 3D geometric shapes are achieved using computer software loadable from a non-transient computer-readable medium, which can be used to calculate the pattern and design specifications in which the physical constraints 2 are printed on the pre-stressed stretchable base material 1 for subsequent transformation to the precise and predetermined 3D geometric shape.

Any 3D printing technology can suitably be used in the present invention to dispose the desired physical constraints 2 on the pre-stressed stretchable base material 1. One example of such a 3D printing technology includes multi-material three-dimensional (3D) printing technologies, which allow for deposition of material patterns with heterogeneous composition. For example, 3D printed structures can be composed of two or more materials that differ in one or more of their physical and chemical properties. The Objet® line of 3D printers (Stratasys Ltd., Israel) can be used for the 3D printing of multi-material objects. Such printers are described in U.S. Pat. Nos. 6,569,373; 7,225,045; 7,300,619; and 7,500,846; and U.S. Patent Application Publication Nos. 2013/0073068 and 2013/0040091, each of the teachings of which being incorporated herein by reference in their entireties. The Stratasys® Connex™ multi-material printers provide multi-material Polyjet™ printing of materials having a variety of properties, including rigid and soft plastics and transparent materials, and provide high-resolution control over material deposition.

One of skill in the art will understand that it may be necessary to cure (e.g., polymerize) the 3D printed physical constraint material (i.e., the formulation or formulations that make up the printed physical constraints). For example, it may be necessary to cure the physical constraint material prior to removal of stress from the stretchable base material, and prior to shape transformation of the stretchable base material.

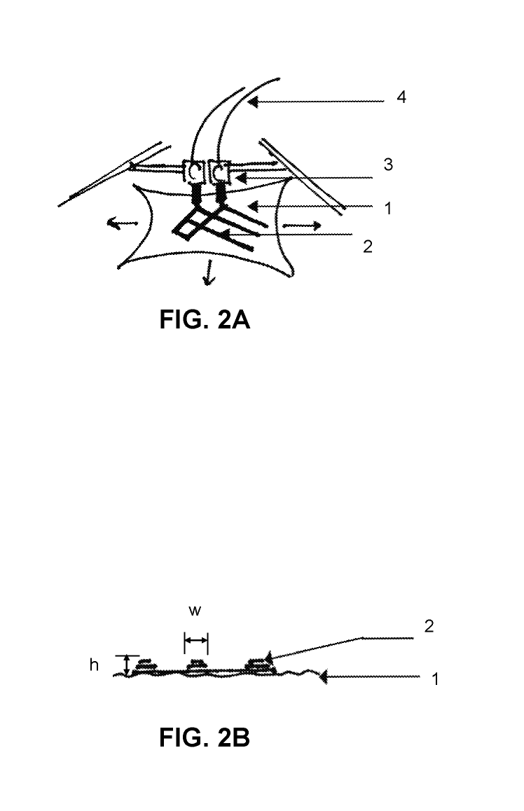

A simplified depiction of 3D printing is shown in FIGS. 2A-2B, in which a printer filament 4 and printer nozzles 3 are positioned so as to deposit the printed constraints 2 onto the per-stressed stretchable base material 1. A side view of the printed physical constraint 2 is depicted in FIG. 2B, in which the physical constraint 2 is provided with a particular height “h” and width “w” which is designed and provided so as to contribute to achieving the desired transformed shape.

According to further embodiments, the physical constraint patterns are deposited onto the pre-stressed stretchable base material through lamination or adhesion. For example, as depicted in FIGS. 2A-2C, one or more physical constraints 2 are formed into the desired patterns to be deposited onto the stretchable base material 1 (e.g., through laser-cutting, CNC routing, or any other method of forming the desired pattern for subsequent lamination or adhesion onto the stretchable base material). Typically the physical constraint 2 is then laminated or adhered to one surface of the pre-stressed stretchable base material 1 as depicted in FIG. 2A. However, in some embodiments, an upper and a lower surface of the stretchable base material 1 may have a physical constraint 2 laminated or adhered thereto, resulting in a pre-stressed stretchable base material 1 sandwiched between the two physical constraints 2. These two physical constraints 2 may be identical as shown in FIGS. 2B-2C, or there may be a different physical constraint on an upper surface than on the lower surface.

This process of laminating or adhering the physical constraint 2 to the pre-stressed stretchable base material 1 creates a similar transformable material as that formed with 3D printing. While this alternate method allows for quick production of the physical constraint 2 on the pre-stretched stretchable base material 1, it can limit the nature of the 3-dimensional structure that can be created since the laser cut or CNC routed laminated sheets cannot be provided with as intricate detail as 3D printed patterns. In particular, 3D printing is particularly beneficial because it allows for a much more complex structures, as well as variable height/width of the physical constraints and, thus, can provide a user with more control over the final transformed shape. Further, with adhesion, the glue or other material used to adhere the physical constraint 2 to the pre-stretched stretchable base material 1 must also be carefully selected because it essentially creates another layer of material having properties that can impact the transformable material. Preferably, thus, glue or other material is selected so that its properties do not interfere with or impact the properties of the stretched stretchable base material 1 and the physical constraints 2 (e.g., it can be a very pliable, stretchable, flexible material that will take on any form that is imposed upon it by the stretchable base material 1 and the physical constraints 2).

As in the implementations using 3D printing, lamination, the pattern, width/thickness and material properties of the added laminated or adhered physical constraints 2 will contribute to, in relation to the direction and force of pre-stressing, the resultant manufactured or transformed shape. Also, using either method, multiple layers of materials and different regions of relatively flexible and stiff materials can be deposited to create a complex physical constraint based on the desired transformed shape. Further, as with 3D printing, one of skill in the art will understand that it may be necessary to cure (e.g., polymerize) the laminated or adhered constraint material (i.e., the formulation or formulations that make up the physical constraints) and any glue or adhesive utilized. For example, any glue or adhesive must be fully cured, and it is generally necessary to cure the physical constraint material prior to removal of stress from the stretchable base material, and prior to transformation of the shape of the stretchable base material—otherwise, the physical constraint 2 may separate from the stretchable base material 1 which will result in the transformed or manufactured shape not being formed.

According to further embodiments, physical constraint patterns may be disposed on the stretchable base material by knitting, weaving, stitching, injecting or other means of adding one or more physical constraint materials with particular properties onto the pre-stressed stretchable base material. As in the implementations using 3D printing and lamination, the pattern, width/thickness and material properties of the added physical constraints 2 will contribute to, in relation to the direction and force of pre-stressing, the resultant manufactured or transformed shape.

According to the present invention, the added physical constraints 2 must be sufficiently bonded to the pre-stretched stretchable base material 1 to provide a successful transformed shape (i.e., one that achieves the final desired transformed shape and holds the transformed shape). This bonding may be produced by 3D printing materials, such as plastics, with the correct melting temperature and material properties to sufficiently bond with the pre-stretched stretchable base material 1. Similar bonding may also be produced with adhesives, a combination of heightened temperature and pressure for a lamination process, or by mechanical means of stitching, riveting or other physical connection means. While not being bound by theory, it is believed that the better the material is bound to the pre-stressed stretchable base material, the more the stretchable base material 1 and the physical constraints 2 will act as a single system and will transform in the correct transformed shape. Separation of the stretchable base material 1 from the physical constraints 2 will generally result in failure of the transformable material to form the transformed shape.

After pre-stressing the stretchable base material 1, depositing the one or more physical constraints 2 onto the pre-stressed stretchable base material 1, and allowing the physical constraints 2 to cure/dry, etc. as needed, the pre-imposed stress upon the stretchable base material 1 is removed to form the transformed shape. In particular, the transformable material is formed by: (1) pre-stressing the stretchable base material 1, (2) deposition of the physical constraints 2, and (2) curing (as needed). The transformed shape, also referred to as the manufactured shape, is formed by: steps (1)-(3) above plus (4) removing the stress from the pre-stressed base material 1.

In certain embodiments, the stretchable base material 1 with the printed/bonded physical constraint thereon is removed from a pre-stretching apparatus (as well as any printing/lamination, etc. apparatus). Generally, after the tension force is removed, the pre-stressed stretchable base material 1 rapidly compresses. If no physical constraint 2 was added to the stretchable base material 1, then the stretchable base material 1 would simply return to its original (“natural”) shape/size and pattern. However, by depositing the physical constraints 2 on/within the pre-stressed stretchable base material 1 in a pre-determined and precise pattern, removal of tension force from the pre-stressed stretchable base material 1 causes the stretchable base material 1 with the physical constraints disposed thereon to transform (as a unit) into a new 3-dimensional structure based on the relationship between the physical constraint pattern and the direction/force of pre-stretch, in addition to the characteristics of all of the materials involved (e.g., the various properties of the stretchable base material 1 and the physical constraint 2 material(s) disposed thereon).

The stress can be removed from the pre-stressed stretchable base material 1 in any manner. The quickest and easiest method of releasing the pre-stretched tension is to simply cut the stretchable base material 1 along an outline of the printed (or otherwise deposited) physical constraint 2 shape. According to the present invention, an automated or manual process can be created to cut the desired shape out of the stretchable base material 1, which may, for example, be held within a pre-stretching apparatus including a rigid substrate or other structural means for pre-stressing and holding the stretchable base material under tension. This will release the tension and will instantly allow the stretchable base material 1 with the physical constraints 2 disposed thereon to jump or otherwise transform into the desired manufactured or transformed shape. A press-cutting method or heat-cutting method may also be utilized to release the stretchable base material 1 from a pre-stressing apparatus. Alternatively, the entire piece of stretchable base material 1, with the physical constraints 2 disposed thereon, may be simply removed from the pre-stressing apparatus, leaving any excess stretchable base material on the outer boundary of the printed constraint material (i.e., “excess” stretchable base material being any stretchable base material located outside of the bounds of the deposited physical constraints, and, thus, not subject to transformation). This excess material can either be removed after releasing the entire piece of stretchable base material, or it may be kept in place in order to provide excess material for patching or bonding the transformed shape to other textile structures, if desired (e.g., for attachment to a sneaker sole, where the transformed shape makes up the remainder of the sneaker).

In contrast to commonly used approaches, the present invention enables the utilization of a single sheet of material, which then self-transforms into any complex 3-dimensional shape. The present invention further eliminates the need for molding and forming techniques, thereby reducing the cost and limitations of a single product type per mold. The present invention also allows for customizable products to be easily produced, and for the development of entirely new types of products that were previously not possible using conventional techniques.

The present invention allows for precise control over 3-dimensional shape transformations in traditionally 2-dimensional textiles without requiring manual forming processes. Complex, precise and pre-determined shapes can be achieved, such as textile detailing, patterning and fashion/apparel texturing (ripple patterns, tufting, pleating, etc.) or larger geometric transformation for comfort, custom fit or openings (sinusoidal waves, various degrees of positive and negative curvature, cut/vents etc.). The present invention produces predictable and unique geometric structures from traditionally passive, flat materials, thereby opening up new opportunities for a variety of products and industrial manufacturing processes. The present invention can be used to create 3-dimensional structures with textiles that previously required patterning, darting and/or patching of various textile pieces. Such techniques are traditionally used in manufacturing clothing, which requires complex curvature and surface topologies. According to the present invention, complex, doubly curved surfaces and 3-dimensional geometries are produced from a flat sheet, thus, eliminating some patching or darting techniques required to produce complex shapes to fit various curvatures of the body. For example, if a textile is needed to wrap the curvature of a body, then various darts, patterns and patches would traditionally be used to accommodate the complex curvature and topological shapes of, for example, the torso. According to the present invention, a single sheet of stretchable base material is pre-stressed and physical constraints deposited thereon, such that the single sheet of material self-transforms into structures having different areas and degrees of curvature designed specifically for the subject's body. Therefore, the present invention does not require manual patching or sewing of different patterns, and can be produced precisely and quickly in an automated fashion.

The present invention further allows for complex and arbitrary details and patterns to be produced without manual stitching or other manual detailing processes. Rather, these details and patterns can be made according to the present invention using fine resolution or using large features with full control over the depth and complexity of the details. For example, according to the present invention, a pleating or tufting technique can be produced across a textile with a gradient in size, depth and intensity or rotation of the detail. This technique would traditionally be nearly impossible, would require extreme skill and excessive time, or would require the use of highly precise and expensive automated machines.

Further, the present invention can provide structures, such as textile-based complex and 3-dimensional interior partitions and other wall treatments, that can be created without subtractive milling of solid material or folding/breaking/forming of rigid sheet goods. In addition, the present invention can further provide self-transforming furniture or other interior products that are packaged in a “pre-transformed state”(e.g., with the stretchable base material being flat and potentially still under a state of stress, with the physical constraints deposited thereon), and which transform into the manufactured shape when removed from the packaging. As such, manual assembly as well as molding and forming processes can be eliminated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transformable material comprising:
a stretchable base material having a natural shape and held under a state of stress in one or more directions; and
one or more physical constraints disposed on and/or within the stretchable base material in a predetermined pattern while the stretchable base material is held under the state of stress,
wherein the one or more physical constraints comprise one or more materials different than the stretchable base materials; and
wherein the one or more physical constraints provide the stretchable base material with a predetermined transformed shape different than the natural shape upon release of the state of stress.

2. The transformable material of claim 1, wherein the stretchable base material is selected from elastomeric materials, textiles, plastics, rubber, and sheet foam.

3. The transformable material of claim 2, wherein the textiles are selected from polyester-polyurethane copolymers, including elastane and spandex, neoprene, jersey, vinyl, stretch velvet, polyesters, compression textiles, and knitted or woven textiles.

4. The transformable material of claim 1, wherein the one or more physical constraints comprise 3D printed physical constraints.

5. The transformable material of claim 1, wherein the one or more physical constraints comprise laminated or adhered physical constraints.

6. The transformable material of claim 1, wherein the one or more physical constraints comprise knitted, woven, stitched, or injected physical constraints.

7. The transformable material of claim 1, wherein the one or more physical constraints are formed of materials selected from non-stretch textiles, plastics, leather, metal, glues, adhesives, calk, composite materials containing resin, and veneer wood, and combinations thereof.

8. The transformable material of claim 6, wherein the one or more physical constraints are formed of plastics selected from the group consisting of nylon, polylactic acid (PLA), acrylonitrile butadiene styrene (ABS), and combinations thereof

9. A method of forming a transformable material comprising:
applying stress to a stretchable base material in one or more directions to form a pre-stressed stretchable base material; and
depositing one or more physical constraints onto or within the pre-stressed stretchable base material in a predetermined pattern to provide a pre-stressed physically constrained stretchable base material,
wherein the stretchable base material has a natural shape before applying stress and before depositing the one or more physical constraints,
wherein the one or more physical constraints comprise one or more materials different than the stretchable base material, and
wherein the one or more physical constraints provide the stretchable base material with a predetermined transformed shape different than the natural shape upon release of the applied stress.

10. The method of claim 9, wherein the stretchable base material is selected from elastomeric materials, textiles, plastics, rubber, and sheet foam.

11. The method of claim 10, wherein the textiles are selected from polyester-polyurethane copolymers, including elastane and spandex, neoprene, jersey, vinyl, stretch velvet, polyesters, compression textiles, and knitted or woven textiles.

12. The method of claim 9, wherein depositing the one or more physical constraints comprises 3D printing the one or more physical constraints in the predetermined pattern onto or within the pre-stressed stretchable base material, laminating or adhering the one or more physical constraints in the predetermined pattern onto or within the pre-stressed stretchable base material, or knitting, weaving, stitching, or injecting the one or more physical constraints in the predetermined pattern onto or within the pre-stressed stretchable base material.

13. The method of claim 9, wherein the one or more physical constraints are formed of materials selected from non-stretch textiles, plastics, leather, metal, glues, adhesives, calk, composite materials containing resin, and veneer wood, and combinations thereof

14. The method of claim 13, wherein the one or more physical constraints are formed of plastics selected from the group consisting of nylon, polylactic acid (PLA), acrylonitrile butadiene styrene (ABS), and combinations thereof.

15. The method of claim 9, wherein depositing the predetermined pattern includes depositing predetermined heights and/or widths of the deposited one or more materials along the pattern.

16. The method of claim 9, further comprising selecting the stretchable base material based on flexibility, stretchability, and resistance of the stretchable base material to applied stress.

17. The method of claim 9, wherein the transformed shape is predetermined by selecting one or more of: a particular shape of the stretchable base material, a stretchability of the stretchable base material, a flexibility of the stretchable base material, a thickness of the stretchable base material, a direction and amount of applied stress, a type of material forming the one or more physical constraints, a thickness pattern of the one or more physical constraints, a width pattern of the one or more physical constraints, an overall design pattern of the one or more physical constraints, and a relative location of the one or more physical constraints to applied stress on the stretchable base material.

18. The method of claim 9, wherein stress is applied to the stretchable base material uniformly in all four directions.

19. The method of claim 9, wherein stress is applied to the stretchable base material non-uniformly so as to impart a preferred direction of force.

20. A method of forming a 3-dimensional transformed shape comprising:
applying stress to a stretchable base material in one or more directions to form a pre- stressed stretchable base material;
depositing one or more physical constraints onto or within the pre-stressed stretchable base material in a predetermined pattern to provide a pre-stressed physically constrained stretchable base material; and
releasing the stress applied to the stretchable base material,
wherein the stretchable base material has a natural shape before applying stress and before depositing the one or more physical constraints,
wherein the one or more physical constraints comprise one or more materials different than the stretchable base material, and
wherein upon releasing the stress applied to the stretchable base material, the one or more physical constraints provide the stretchable base material with a predetermined transformed 3-dimensional shape different than the natural shape of the stretchable base material.

21. The method of claim 20, wherein the stretchable base material is selected from elastomeric materials, textiles, plastics, rubber, and sheet foam.

22. The method of claim 21, wherein the textiles are selected from polyester-polyurethane copolymers, including elastane and spandex, neoprene, jersey, vinyl, stretch velvet, polyesters, compression textiles, and knitted or woven textiles.

23. The method of claim 20, wherein depositing the one or more physical constraints comprises 3D printing the one or more physical constraints in the predetermined pattern onto or within the pre-stressed stretchable base material, laminating or adhering the one or more physical constraints in the predetermined pattern onto or within the pre-stressed stretchable base material, or knitting, weaving, stitching, or injecting the one or more physical constraints in the predetermined pattern onto or within the pre-stressed stretchable base material.

24. The method of claim 20, wherein the one or more physical constraints are formed of materials selected from non-stretch textiles, plastics, leather, metal, glues, adhesives, calk, composite materials containing resin, and veneer wood, and combinations thereof

25. The method of claim 24, wherein the one or more physical constraints are formed of plastics selected from the group consisting of nylon, polylactic acid (PLA), acrylonitrile butadiene styrene (ABS), and combinations thereof.

26. The method of claim 20, wherein depositing the predetermined pattern includes depositing predetermined heights and/or widths of the deposited one or more materials along the pattern.

27. The method of claim 20, further comprising selecting the stretchable base material based on flexibility, stretchability, and resistance of the stretchable base material to applied stress.

28. The method of claim 20, wherein the transformed shape is predetermined by selecting one or more of: a particular shape of the stretchable base material, a stretchability of the stretchable base material, a flexibility of the stretchable base material, a thickness of the stretchable base material, a direction and amount of applied stress, a type of material forming the one or more physical constraints, a thickness pattern of the one or more physical constraints, a width pattern of the one or more physical constraints, an overall design pattern of the one or more physical constraints, and a relative location of the one or more physical constraints to applied stress on the stretchable base material.

29. The method of claim 20, wherein stress is applied to the stretchable base material uniformly in all four directions.

30. The method of claim 20, wherein stress is applied to the stretchable base material non-uniformly so as to impart a preferred direction of force.

31. A method of material transformation comprising:
applying stress to a stretchable base material in one or more directions to form a pre-stressed stretchable base material;
depositing one or more physical constraints onto or within the pre-stressed stretchable base material to provide a pre-stressed physically constrained stretchable base material; and
releasing the applied stress from the pre-stressed physically constrained stretchable base material,
wherein release of the applied stress from the pre-stressed physically constrained stretchable base material causes the physically constrained stretchable base material to take on a transformed shape.

32. The method of claim 31, wherein the one or more physical constraints are in the form of one or more materials deposited onto or within the pre-stressed stretchable base material in a predetermined pattern.

33. The method of claim 31, wherein depositing the one or more physical constraints comprises 3D printing the one or more physical constraints in a predetermined pattern onto or within the pre-stressed stretchable base material, laminating or adhering the one or more physical constraints in a predetermined pattern onto or within the pre-stressed stretchable base material, or knitting, weaving, stitching, or injecting the one or more physical constraints in the predetermined pattern onto or within the pre-stressed stretchable base material.

34. The method of claim 31, wherein releasing the applied stress from the pre-stressed physically constrained stretchable base material comprises cutting the stretchable base material along an outline of the deposited one or more physical constraints.

35. The method of claim 31, wherein applying stress to the stretchable base material comprises holding the stretchable base material in a stressing apparatus, and wherein releasing the applied stress comprises releasing the stretchable base material from the stressing apparatus.

36. The method of claim 31, further comprising selecting the stretchable base material based on flexibility, stretchability, and resistance of the stretchable base material to applied stress.

37. The method of claim 31, wherein the transformed shape is predetermined by selecting one or more of: a particular shape of the stretchable base material, a stretchability of the stretchable base material, a flexibility of the stretchable base material, a thickness of the stretchable base material, a direction and amount of applied stress, a type of material forming the one or more physical constraints, a thickness pattern of the one or more physical constraints, a width pattern of the one or more physical constraints, an overall design pattern of the one or more physical constraints, and a relative location of the one or more physical constraints to applied stress on the stretchable base material.

38. The method of claim 31, wherein stress is applied to the stretchable base material uniformly in all four directions.

39. The method of claim 31, wherein stress is applied to the stretchable base material non-uniformly so as to impart a preferred direction of force.

40. The method of claim 20, wherein the transformed shape is the shape of footwear, clothing, an architectural structure, furniture, a wall partition, a window treatment, a compression garment, an automotive interior structure, or an aerospace interior structure.

41. A 3-dimensional transformed shape comprising the transformable material of claim 1 after release of the state of stress.

42. The 3-dimensional transformed shape of claim 41, wherein the predetermined transformed shape is in the shape of footwear, clothing, an architectural structure, furniture, a wall partition, a window treatment, a compression garment, an automotive interior structure, or an aerospace interior structure.
